(19) United States
(12) Patent Application Publication
(10) Pub. No.: US 2008/0277354 A1
(43) Pub. Date: Nov. 13, 2008

(54) Ballast Water System

(76) Inventors: Gunnar Baerheim, Drammen (NO); Stein Foss, Drammen (NO); Kjell Varenhed, Helsingborg (NO); Aage Bjorn Andersen, Raelingen (NO)

Correspondence Address: ROTHWELL, FIGG, ERNST & MANBECK, P.C., 1425 K STREET, N.W., SUITE 800, WASHINGTON, DC, 20005, US

(21) Appl. No.: 11/596,179

(22) PCT Filed: May 11, 2005
(86) PCT No.: PCT/GB05/01838

§ 371 Date: Nov. 26, 2007

(30) Foreign Application Priority Data
May 11, 2004 (GB) 0410478.2
Dec. 16, 2004 (NO) 20045500

(51) Int. Cl. C02F 1/34; C02F 1/68; B63B 13/00

(52) U.S. Cl. 210/750; 210/764; 210/206; 210/205; 210/749; 210/198.1; 210/120; 210/143

(57) ABSTRACT

A system and method for treatment of water contaminated with organisms, in particular ballast water in ships, the system including a pump (5) pumping water from the sea trough a cavitation unit (7) and into one or more ballast tanks. The cavitation unit (7) will introduce a strong cavitation in the water, the cavitating action destroying any organic tissue and cell membranes of organisms present in the water. In the cavitation unit (7) hydrogen and steam are added to the water, while oxygen is removed. The oxygen-depleted water will exhibit a reduced corrosive effect on the ballast tanks.

This invention relates to a method of treating ship's ballast water to reduce biological contamination and to apparatus for use in such a method.

When a ship unloads cargo in one port, to prevent the departing unloaded or partially loaded ship from being unstable while at sea, sea water is generally pumped into the ship's ballast tanks at that port. This operation can and usually does result in local marine species (e.g. bacteria, and multicellular species) entering the ballast tank. When the ship reaches its next port of call where loading is to occur, the ballast water must be pumped out. If this water contains live biological material this can result in biological contamination of the marine environment of that port as explained below.

All modern ships have integrated ballast water arrangements including pumps, filters, pipes, ventilators and tanks. The ballast water tanks may be located between the skins in a double walled hull but may also represent any other void space or spaces found suitable for the purpose. When a ship has unloaded its cargo, in full or by part, it will go to another port to take onboard another load of cargo. On the return trip with partly empty or empty cargo holds or tanks, the ballast tanks may be filled with water in order to stabilize the ship in the sea, to secure proper immersion of the propellers and rudders, to achieve reasonable vessel trim and/or to ensure that any structural limitations regarding the vessels structural integrity is not exceeded. The ballast tanks are normally filled with seawater from the vicinity of the cargo unloading port, the donor port. When approaching the recipient port where it will receive new cargo, ballast water is discharged into the surrounding sea.

This world-wide transport of ballast water raises concerns as to its environmental impact. When the ballast tanks are filled with water from a port, this water will contain a number of organisms representative of the donor port. This may be seaweed, algae, larvae of fish, fish, molluscs or other living organisms, parasites of different kind, bacteria and viruses, etc. When released in another part of the world, these organisms may find an unoccupied niche in the ecological system and start reproducing, without their natural enemies present. It is known that species of plants and animals has been introduced in environment outside their natural habitat and thus created large problems at the new location.

Intergovernmental authorities have developed an international convention, the International Convention for the Control and Management of Ships' Ballast Water and Sediments, for the purpose of reducing the risk of introductions of non-native aquatic species. This is considered an important step in order to protect biological diversity. According to these regulations, newly constructed ships must implement means of onboard processing of ballast water to ensure a defined ballast water performance standard at point of discharge (recipient port) from 2009 on. All ships are subjected to the same requirement from 2016. At present there is no technology available, feasible for shipboard installation, for treatment of ballast water that has demonstrated compliance with reference to the forthcoming regulations. Some industrial water treatment technologies may satisfy requirements for treatment quality as set out in the convention, but may have characteristics that are not compatible for shipboard use or maybe not even possible to incorporate into a ship.

Filtration is the most common and simple method to reduce the concentration of unwanted organisms in ballast water beside ballast water exchange in open sea in the art. Most commercial ships screen ballast water through a 15 mm sieve or similar, at the sea chest and/or hull fitting. This simple screen filter may be combined with cyclonic separators. However, such a filter/separation configuration will only remove larger organisms, such as fish, invertebrates and large macrophytes, while other organisms typical to ballast water, such as bacteria, virus, fungi, protozoa, plankton and egg and larvae of higher life forms will pass through.

Cyclonic separators operate on the principle of density differences between fluids (in this case ballast water) and particles (specie/organisms present). For ballast water applications, such difference does not always occur. Thus, cyclonic separators may not be feasible for ballast water separation applications.

Narrow mesh filters may remove eggs and larvae completely, and large plankton and protozoa. However, such filters will create an increased back-pressure, may soon become clogged during operations, and has proven inadequate for filtrating ballast water at the flow rates in question.

Ballast water exchange in open sea is the only present actively initiated shipboard measure applied for the purpose of managing the risks of ballast water transfer operations. The principle of this exercise is simply that of dilution resting on the assumption that open sea water contain a lesser concentration of organisms than that of the coastal or port water used for ballasting and consequently represent a lower risk to the recipient port.

From U.S. Pat. No. 5,932,112 to Browning there is known a system for de-oxygenating ballast water in order to kill organisms. Oxygen is removed in a vacuum process with a subsequent injection of exhaust gases from the ship's machinery. Studies have shown that de-oxygenation appears to be highly effective at killing animal invaders (larval, juvenile and adult forms), but may be less effective for other species; particularly those adapted to low oxygen environments or with resistant stages such as cysts. The injection of hot exhaust gases containing high levels of CO/CO₂ appears to be less desirable as this may promote corrosion.

WO 03/093176 to McNulty discloses a system and method of ballast water treatment. Water is pumped through a venturi injector where a oxygen stripping gas is added as micro-fine bubbles. Due to the large surface of the bubbles, oxygen gas present in the water is exchanged with the stripping gas. The water is then pumped to the ballast tanks, where the oxygen is vented off. This system has both a killing effect for organisms, and a corrosion inhibiting effect. However, certain organisms may survive the treatment, as in the system mentioned above.

Norwegian patent 314625 (Forinnova AS) describes a method for treatment of ballast water by establishing a supersaturated gas condition in the water. When fish are exposed to gas supersaturated water, they will develop “gas bubble disease”, also known as “divers' disease”. The supersaturated gas will replace oxygen in the blood, and emerge as bubbles in blood and body tissue. The preferred gas is air, but it is stated that nitrogen gas may be used in some applications. Supersaturation will effectively kill larger organisms, such as fish (organisms with a system of circulation), but is less effective or ineffective for small organisms, such as plankton.

Thus there is an ongoing need for techniques by which biological contamination by discharged ballast water may be reduced or eliminated.

Viewed from one aspect the present invention provides a method of ballast water treatment which comprises: pumping water from a water source (e.g. surrounding sea, lake or river) through a filter to the ballast tank of a water-going vessel; raising the dissolved nitrogen content of at least part of said water to a level above the nitrogen saturation content thereof whereby the water in said ballast tank when pumping is terminated is above the nitrogen saturation content thereof and below the oxygen saturation content thereof; maintaining in the headspace of said ballast tank an atmosphere having greater than atmospheric content of nitrogen (in mole %); pumping water from said ballast tank into the water surrounding said vessel; and subjecting the water pumped from said ballast tank to a microorganism-killing action before the release thereof into said water surrounding said vessel.

Viewed from a further aspect the invention provides an apparatus for the treatment of ballast water for a water-going vessel, said apparatus comprising: a first pump for pumping water through a filter and into a ballast tank; a filter through which water may be pumped by said first pump; a conduit for carrying water from said first pump through said filter to said ballast tank; a nitrogen introducer for introducing nitrogen into water being pumped from said first pump to said ballast tank; optionally a nitrogen source attached or attachable to said nitrogen introducer; a second pump (which may optionally and preferably be said first pump) for pumping water from said ballast tank through a conduit and out of said vessel; a microorganism killing unit arranged to kill microorganisms in water being pumped from said ballast tank and out of said vessel.

Viewed from a yet further aspect the invention provides a water-going vessel having a ballast water tank, characterized in that said vessel further comprises apparatus according to the invention for treating ballast water.

While nitrogenation of the ballast water being loaded into the ballast tank has the primary effect of killing mono- and multicellular organisms entrained in the ballast water or present in the ballast tank, a further advantage of the method and apparatus according to the invention is that the nitrogen supersaturated ballast water also serves to reduce corrosion of the ballast tanks. This is of particular benefit as repairing or replacing corroded ballast water tanks is one of the most expensive items in the refitting of ships.

Corrosion of ballast water tanks substantially limits the operational life of vessels. At present, fleet operators attempt to prolong the operational life of vessels by painting the internal surfaces of the ballast tanks. This is a costly and difficult task, particularly where large amounts of mud and debris have to be removed from the tanks before they can be painted.

Corrosion and/or oxidation of protective coatings (e.g paints) in ballast water tanks are a matter of major concern for shipping companies throughout the world not least for the reasons outlined above. The ballast tanks are an important structural element of any ship, and the corrosion in these areas will jeopardise the structural integrity of the vessel and effectively limit the life span of the ship. Ballast tanks are initially coated with a system of corrosion protective coatings. The layers of coatings are gradually weathered and degraded over time by the frequent change in exposure between water and air until it must be replaced (in full or by part) after typically some 5-10 years time. From then on, there is a steady ongoing process of repairs, paint stripping and repainting of the ballast tanks. This may take place during repair works at a repair yard or by hired crews onboard the vessel between ports. In some vessels, in particular those of some age, the ballast tanks may not be coated.

The main corrosion mechanisms are that of electrochemical reactions occurring when metal objects are exposed to an oxidising environment, usually under wet or moist conditions. The corrosion in the ballast tanks is caused by the steel of the ships tank structure being in contact with salt seawater, acting as an electrolyte, and oxygen in the air or dissolved in the water. There are several parameters that have impact on the rate of coating degradation by oxidation as well as corrosion. The highest corrosion rates are usually found in the upper part of the top tank, in the outward facing plating. This is explained by the combined effect of increased average temperature due to sun heating, abundant oxygen supply (air), splashing of sea water, and cyclic temperature changes leading to cyclic condensation of water and drying.

The development of corrosion protection measures has resulted in improved corrosion protective coatings influenced by changes in environmental legislation (limiting the use of certain toxic compounds), and the formulation of better performing multi-part epoxies and other coatings. Studies have also shown that an overall reduction of corrosion in ballast tanks of about 90% can be achieved by de-oxygenating the ballast water when the tanks are full. This effect will be strengthened further if oxygen levels are reduced also when the tanks are empty. De-oxygenation may be achieved by applying a “stripping” gas e.g. nitrogen directly to the tank. For the gas to displace the dissolved oxygen efficiently, it must be more readily dissolvable in water than oxygen.

It will be appreciated that aspects of the present invention provide a solution to the problems of ballast tank corrosion.

The pump used to load the ballast water into the ballast tank according to the invention and generally also to discharge the ballast water from the ballast tank may be a conventional ballast water pump. While this could be positioned on a service vessel, on the dock or elsewhere off the ship, it will preferably be on board the ship. Such pumps generally have a capacity of 100-12000 m³/hour, e.g. 400-1000 m³/hour.

The filter through which the incoming ballast water is passed preferably has a pore size small enough to retain multicellular organisms. If desired pore sizes small enough to retain bacteria may be used. Filters having a pore size of 10 to 100 μm, especially 20 to 50 μm. Preferably the filter is an automatically back-flushing mechanical filter. Nitrogen introduction into the ballast water may be effected before or after passage through the filter. Post-filter introduction is however preferred.

Nitrogen may be introduced into the part or all of the inflowing ballast water. In certain embodiments of the invention it has been found that it is more economical to nitrogenate only part of the ballast water flow. Thus it has been found that very satisfactory results are obtained if the water flow to the ballast tank is split and nitrogen is introduced into one of the separate flows, e.g. one comprising 5 to 80%, preferably 8 to 30% of the total water flow. The quantity of nitrogen introduced however is preferably such that the ballast water in the ballast tank, on cessation of pumping, is at least 110% nitrogen saturated, more preferably at least 120% nitrogen saturated, still more preferably at least 130% nitrogen saturated, e.g. up to 135% or even 145% nitrogen saturated. The nitrogen content of the ballast water in the ballast tank is preferably monitored continuously or occasionally, e.g. using dissolved gas sensors. Particularly desirably the nitrogen content is monitored during transit, i.e. up to ballast water discharge. Using up to 145% nitrogen supersaturated ballast water, nitrogen supersaturation can readily be maintained in a closed ballast tank for 10 to 15 days, i.e. long enough for most voyages.

The nitrogen injector used in the method and apparatus of the invention may be any appropriate device for introducing nitrogen into water to achieve nitrogen supersaturation, e.g. a perforated tube supplied with an overpressure of nitrogen gas. Particularly preferably however the injector is a Venturi injector, i.e. a constricted section of the water conduit with nitrogen injection ports in the walls of that section. One such Venturi injector is described for example in U.S. Pat. No. 6,505,648. Nitrogen gas is preferably piped to the inlet ports at a pressure above that of the water in the conduit. Where a Venturi injector is used however it is particularly desirable to nitrogenate only a part of the total water flow and to have a further pump arranged to force the water through the construction. Typically the nitrogen flow rate at such Venturi injector may be 10 to 220 m³/hour, preferably 25 to 100 m³/hour, especially 35 to 80 m³/hour, depending on the pumping capacity.

While it is preferred to use substantially pure nitrogen (e.g. at least 90% N₂, especially at least 95% N₂, more particularly at least 99% N₂) as the feed to the nitrogen injector, less pure nitrogen is acceptable as long as the content of acidic or oxidizing gases (e.g. oxygen or oxides) is low. Generally it is preferred that the nitrogen content of the feed gas is 85% or more. Thus a nitrogen/noble gas mix may be used; however this will rarely be economically justified. Especially preferably the oxygen content is less than 15%, particularly less than 10%, more particularly less than 2%, especially less than 1%. The nitrogen supply to the nitrogen injector may again be on-ship or off-ship. An on-ship supply is generally to be preferred as it may be desirable in transit to introduce further nitrogen into the ballast tank. The supply may take any convenient form, e.g. a nitrogen generator, compressed gas reservoirs, liquefied gas reservoirs, etc.

If a compressed or liquefied gas reservoir is not used it may be desirable to incorporate a pump and/or a heat exchanger into the nitrogen supply line.

Before, during or after ballast water loading, the ballast tank may if desired be flushed with nitrogen (or other oxygen depleted gas). The headspace of the ballast tank is also desirably equipped with a gas sensor, in particular a nitrogen and/or oxygen sensor, to ensure that during transit the headspace is oxygen poor relative to air. Alternatively the gas sensor may be located outside of the ballast tank and arranged to receive a sample from inside the ballast tank. If the oxygen content rises, the nitrogen content of the headspace may be increased by addition of nitrogen. In this way ballast tank corrosion may be reduced. It is also particularly desirable that empty or part-empty ballast tanks be maintained with a nitrogen-rich, oxygen-poor atmosphere to inhibit corrosion even in the absence of ballast water.

To enhance the biocidal effect of the treatment of the ballast water being loaded into the ballast tank, it may be desirable to incorporate a further microorganism killing unit in the conduit leading from the ballast water uptake port to the ballast tank. This may be a microorganism killing unit as described below in connection with ballast water discharge (and indeed may even be the same unit); however the use of a cavitation generator, e.g. a propellor (or leading edge thereof) within the conduit, is especially preferred. Heat and more especially chemical treatment are not preferred.

The ballast tank is preferably provided with a valve so that overpressure in the headspace may be vented and so that underpressure in the headspace may be corrected for, e.g. by the admission of air or more preferably of nitrogen. Typically such a valve should be activated by a pressure differential to atmospheric of at least 40 to 120 mm H₂O, more preferably at least 50 mm H₂O, e.g. one of about 60 mm H₂O. When the pressure differential is less than the pre-set limit the valve should be closed. A single valve may react to over and underpressure or a combination of valves reacting to overpressure and valves reacting to underpressure may be used.

It is also preferred that a relatively coarse filter, e.g. with a pore or mesh size of no more than 2 mm, preferably no more than 1 mm is placed after the pump. It is also preferred that a coarse filter or grid or mesh is placed at the ballast water inlet port, i.e. where the ballast water enters from the surrounding water source (e.g. sea, lake or river) so as to prevent uptake of fish, weed, or other larger debris.

When discharge of the ballast water is to take place, the ballast water pump is used to pump the ballast water out of the ballast tank, past a microorganism killing unit, and an oxygen introducer and into the surrounding water. The microorganism killing unit serves to kill microorganisms that survived ballast water loading and that have grown in the ballast tanks during transit. Any appropriate microorganism killer unit may be used; however units which achieve their biocidal effect by the addition of microbicidal chemicals are preferably not used. Typical examples of appropriate units include those which expose the discharging water to electroshock, irradiation, ozone, heat, or pressure change, e.g. UV or ultrasound irradiation, electroshock (e.g. using AC or DC 100-500 V, typically 200-300 V, and up to 150 Amp, e.g. 20 to 50 Amp), a Venturi ozone injector, a cavitation device, etc. The use of electric treatment is one particularly preferred embodiment.

In a particularly preferred embodiment of the invention, the apparatus includes an oxygen introducer arranged to introduce oxygen into the ballast water being discharged from the ballast tank. In this way the water may be discharged having an oxygen content closer to that of the surrounding water into which the ballast water is discharged. This will prevent undesired effects on the local aquatic organisms. The oxygen introducer may take any convenient form, e.g. as described for the nitrogen introducer above, however a Venturi introducer is preferred. The oxygen introducer may typically use oxygen from an oxygen source, e.g. a pressurized reservoir, or air or oxygen-enriched air. For example oxygen-enriched air could be used with an oxygen content of up to 40%. Alternatively the oxygen introducer may receive an oxygen feed from the nitrogen generator. Where the microorganism killing unit in the apparatus involves nitrogen introduction or introduction of other oxygen-poor gases, the oxygen introducer will preferably be downstream of the killing unit.

Downstream of the gas introducers (e.g. N₂ or O₂ introducers), the conduit may desirably contain static mixers, e.g. corrugated baffles with the corrugations alternatingly arranged at + and −45° to the flow direction as described in WO 03/016460.

The ship for which ballast water is treated according to the invention may contain a single ballast tank or more generally two or more ballast tanks. These may be compartmentalized and the ship may be provided with a pump to transfer ballast water between tanks or compartments during transit. If this is the case, it is preferred that the apparatus be provided with means for introducing nitrogen into the tanks or compartment headspace(s) before, during or after such transfer. Moreover the pumping circuit for such transfer may if desired incorporate a nitrogen injector to maintain nitrogen supersaturation of the ballast water.

While it is greatly preferred to nitrogenate the ballast water being loaded into the ballast tank as described above, the combination of filtration, especially fine pore size filtration (e.g. using a bag filter), and a microorganism killing unit arranged in the conduit from ballast water uptake port to ballast tank and/or from ballast tank to ballast water discharge port, especially an electric (e.g. electroshock) killing unit is itself novel and forms a further aspect of the invention. Thus viewed from this aspect the invention provides a method of ballast water treatment which comprises: pumping water from a water source (e.g. surrounding sea, lake or river) through a filter to the ballast tank of a water-going vessel; pumping water from said ballast tank into the water surrounding said vessel; and subjecting the water pumped both to and from said ballast tank to a microorganism-killing action before the release thereof into said water surrounding said vessel.

Viewed from a still further aspect the invention also provides an apparatus for the treatment of ballast water for a water-going vessel, said apparatus comprising: a first pump for pumping water through a filter and into a ballast tank; a filter though which water may be pumped by said first pump; a conduit for carrying water from said first pump through said filter to said ballast tank; and a microorganism killing unit arranged to kill microorganisms in water being pumped both to and from said ballast tank.

In such methods and apparatus, it is again preferred to include oxygen introduction into the ballast water before discharge so as to avoid the undesirable effects on local aquatic organisms of the discharge of oxygen-poor ballast water.

Another aspect of an invention disclosed herein relates to a method and arrangement for treatment of ballast water which is far more effective in killing unwanted organisms in ballast water compared with the prior art methods described above, and provides an improved protection against corrosion in the ballast tanks.

Thus, viewed from one aspect the invention provides a method for treatment of ballast water, said method comprising pumping water from a first repository, adding steam to the water, adding a further gaseous material to the water, introducing a cavitation action in the water, and conducting the water to a second repository.

Viewed from a further aspect the invention provides an arrangement for treatment of ballast water, including a pump pumping water from a first repository, characterized in that said arrangement comprises means for adding steam to the water, means for adding a further gaseous material to the water, means for introducing a cavitation action in the water means for conducting the water to a second repository.

Viewed from a still further aspect the invention provides a device for treatment of ballast water, for use in an arrangement as defined above characterized in that said device comprises a liquid inlet pipe supplying ballast water to the liquid treatment device, an intake chamber connected to the inlet pipe, a conical section connected to the intake chamber, a tube connected to the conical section, a cavitation chamber connected to the tube, a liquid outlet tube connected to the cavitation chamber and conducting the liquid from the cavitation chamber, and at least one gas supply tube supplying steam and a further gaseous material to the intake chamber.

Viewed from another aspect the invention provides a device for treatment of ballast water, for use in an arrangement defined above characterized in that said device comprises a liquid inlet pipe supplying a liquid to the liquid treatment device, a tapered section connected to the inlet pipe, a cavitation chamber connected to the tapered section, a liquid outlet tube connected to the cavitation chamber and conducting the liquid from the cavitation chamber, means for adding steam and a further gaseous material to the intake chamber.

The cavitation-based system will expose organisms present in the ballast water to extreme physical conditions consistent with pulsed shock waves that effectively destroy body tissue and cell membranes. An integrated process will remove most of the oxygen dissolved in the water and enable the establishment of a controlled near-oxygen-free atmosphere in the ballast tanks. The near-oxygen-free atmosphere will further eliminate any organisms that may have survived the pulsed shock wave exposure but require a surplus of oxygen for survival and act preventive against potential re-growth of any other organisms. It will also reduce surface oxidation of any corrosion protective coatings or paint systems in the tanks, and effectively reduce the corrosion rate substantially, with about 90% or even more. The oxygen-free atmosphere in the ballast tanks will eliminate the danger of explosions in said tanks; this is particularly relevant for any tankers carrying oil or chemicals or any other cargo that may generate explosive atmospheres during a voyage. As a consequence of means applied to remove dissolved oxygen from the water, the water will become supersaturated and thus expose organisms, in particular those with a complex system of circulation to bubble disease. The degree of mortality has proven to be high through different studies. Other organisms with less complex circulation systems have also proven to be vulnerable when exposed to supersaturation. This is in particular the case as the degree of supersaturation increases.

In summary, steam containing an oxygen stripping gas is applied at the point of injection or close to the point of injection to the ballast water line either at uptake, discharge or both. This will create a pumping or boosting effect which is utilised to deliver ballast water to an apparatus increasing the speed of the water and consequently reducing the internal pressure of the water. The said steam and gas mixture will change the gaseous composition of the water and thus alter its characteristics including that of its vapour point. At a certain point in the process, the pressure will have reached a level or close to a level at which cavitation occur, creating extreme physical conditions consistent to that of pulsed shock waves. These conditions will destroy a large part of the organisms in the water.

The combination of steam/gas injected into the water will displace a significant proportion of the dissolved oxygen in the water. Cavitation itself will enhance the process of de-oxygenation leading to a further reduction in the level of oxygen remaining in the water. Following cavitation, the flow will be two-phased; liquid and gas.

Since the liquid phase will be saturated or supersaturated, the gas-phase which consists largely of released oxygen will remain stable and will not dissolve back into the liquid.

The replacement of oxygen in the treated water will promote the killing of organisms that have survived the cavitation step, and protect the tanks against corrosion and the coating against oxidation. Adding steam will boost the water flowing through, thus attaining a flow rate necessary to obtain a stable cavitation in an energy efficient manner. This will eliminate the need for excessively large pumps. It is also beneficial for the oxygen-gas exchange, as it will promote the formation of a significant number of small bubbles in the water representing in sum a large surface area. The use of steam as a medium to dissolve gas in liquids is considerably more efficient than prior art processes.

The gas will be a gaseous material, i.e. something other than water that is gas at STP. For the purpose of treating water at uptake, the gas should be of less than 15% mole oxygen, preferably less than 10% or if feasible, less than 5% or less than 1% with the rest being nitrogen or a noble gas. On discharge, the gas should preferably contain more than 15% mole oxygen. Thus, water may be efficiently treated in the short time span available from being pumped in from the sea and until it is delivered into the ballast tanks or discharged overboard. The process may be combined with other treatment principles, apparatuses or processes in order to achieve a further degree of species elimination or some other desired characteristic. This may relate to reception facilities at the ballast water discharge port.

As discussed above, it is common practice for vessels to discharge water carried in ballast tanks into the sea before the vessel is loaded with its intended cargo. The national law of the relevant country defines the distance from the coast at which a vessel must discharge the ballast water. For example, Canadian law defines a distance of 200 nautical miles from the coast for vessels to empty ballast tank water.

Compliance with these requirements is assessed by the coastal authorities of the relevant country who attempt to determine if the ballast tanks have been emptied at the appropriate distance from the coast. It is not at present possible to authenticate any claim that the ballast tanks of a ship have been emptied in compliance with the relevant laws, not least because of the distance at which the vessels are required to empty ballast tanks.

There is therefore a need for a system which allows a coastal authority to determine if the laws of the relevant country have been complied with.

Thus, an aspect of another invention disclosed herein provides a ballast water control system comprising a control unit and data storage means, the control unit being arranged to receive an indication that a ballast water tank has been emptied and an indication of the coordinates of the vessel and to store both indications in said data storage means.

By interrogating the data storage means, the coastal authorities are provided with a means to determine the precise location at which the ballast water tanks were discharged.

The control unit and data storage unit may be any suitable arrangement. For example, a conventional microcomputer with data storage means such as a hard disk drive or the like may be provided. Alternatively, the system may be incorporated and integrated into the vessel's control systems.

If desired the data storage means may be remote from the ship and may store data relating to ballast water uptake and/or discharge for more than one ship. One example of such a system is an internet-accessible database.

The position of the vessel may be determined using any suitable means. Preferably, to ensure accuracy, the international global positioning system (GPS) is used to provide the coordinates of the vessel to the control unit. The coordinates of the ship may be provided by communication with the ship's navigation systems. Alternatively, the position may be provided or determined using other techniques such as by triangulation with radio transmitters.

The control unit may determine that the ballast tanks have been emptied by means of a control signal from the ballast water discharge pumps or control system, for example indicating that the tanks are or have been emptied. Alternatively, the control unit may receive a signal from a level sensor or other suitable sensor disposed in or near to the ballast water tanks indicating that the tank has been emptied e.g. by a substantial change in water level.

Preferably, the signal indicating that the ballast tanks are being emptied is or includes an indication that the tank(s) have been completely emptied. This may, for example, be by means of a water level sensor or by a timer indicating the run-time of the discharge pump(s).

The indication that the tanks have been emptied and the indication of the location of the vessel when the tanks were emptied is preferably stored in data storage means, for example in a database.

The control unit and data storage means may also be arranged to record the time of unloading, time of loading, water temperature etc. The control unit and data storage means may also, using suitable sensors, be arranged to record ballast water conditions in the tank or other information regarding the ballast water such as salinity, N₂ content etc. This may be recorded and stored over the entire journey of the vessel.

The database and/or control unit may also be provided with information relating to the laws of a particular country and may further be arranged to indicate, by comparing the location of the vessel with the laws, if the laws have been complied with. Thus, the coastal authority can easily determine if the vessel has complied with the law.

Preferably, the vessel data is also remotely accessible by the coastal authorities via a suitable communication link such that the coastal authorities do not have to visit the vessel before docking at a port.

The vessel data may be transmitted directly to the coastal authorities or alternatively may be transmitted to a third party who can verify the data on behalf of the coastal authority and then inform them accordingly. Such as third party may, for example, be an organisation such as DNV. In this arrangement the location of the vessel may be determined independently from the ship's data, for example by satellite tracking or the like.

As discussed above, in one arrangement the conditions of the ballast water may be monitored over the journey of the vessel, using appropriate sensors disposed in or around the ballast tanks. In this way the conditions within the ballast tanks can be maintained at optimal levels.

However, over prolonged periods of operation sensors are prone to degradation particularly when disposed within the ballast tanks.

Thus, in order to overcome this problem the sensor(s) are preferably disposed outside of the ballast tanks and are fluidly connected to the tanks using a suitable conduit or conduits. Preferably the sensors are arranged to return the ballast water to the tanks thereby maintaining the ballast tank volume whilst continuously monitoring the ballast water conditions.

Thus, viewed from a still further aspect there is provided a ballast water tank monitoring apparatus comprising at least one conduit having a first end disposed within a ballast water tank and a second end fluidly communicating with at least one sensor wherein the at least one sensor is disposed outside of said ballast water tank.

The sensor(s) may be arranged to monitor a number of parameters e.g. oxygen content, nitrogen content, salinity, pH and temperature. It is thereby possible to closely monitor changes in the ballast water and also the ballast tanks over extended periods.

The sensor(s) may receive ballast water from a plurality of conduits having distal ends disposed at various positions in the ballast tank(s). Preferably the sensor(s) are arranged to receive ballast water from each ballast tank and particularly from the ballast tank cavity at the bottom of the vessel which is conventionally the most difficult to reach.

Ballast water may be communicated to the sensor(s) via a number of fixed conduits extending from the sensor(s) to parts of the ballast tanks. Alternatively, the sensors may be connected to one or more extendable conduits arranged to extend into the ballast tanks so as to be able to receive ballast water from specific positions within the tank(s). In this arrangement the conduit(s) may be arranged to move on guides or tracks fixed to the ballast tank(s) so as to accurately guide the conduit around the tank(s).

This arrangement may also be connected to the ballast water control unit discussed above, thereby allowing the conditions within the ballast tank(s) to be monitored and matched with GPS and time data.

During loading and unloading of ballast tanks it is essential that gas is allowed into or out of the tanks as the water level changes. Conventional vessels are provided with ballast tank valves which can be opened to allow for the movement of air. In addition, valves need to be provided which allow for thermal changes in the tanks over the journey of the vessel. For example, entering tropical regions will increase the temperature in the ballast tanks thereby increasing the pressure in the headspace. Shipping classification societies require adequate ventilation to avoid pressure build-up (or under-pressure).

In the case where nitrogen is introduced into the ballast tanks, as disclosed herein, there is a further need to allow air to leave the tanks as the nitrogen is introduced.

There is therefore a need for a valve capable of regulating the pressure in a ballast tank and which provides adequate ventilation for ballast tanks in accordance with classification society requirements.

Thus, viewed from a still further aspect, there is provided a ballast water tank pressure relief valve for a ship, comprising a conduit having a first and second portion and a middle portion disposed there between arranged in use to contain a liquid so as to provide a seal between said first and said second portions.

The conduit may for example be formed of a pipe bent into a U-section wherein the middle portion is defined in the U-section and the first and second portions extend in a generally vertical direction there from. This arrangement is particularly convenient for use in vessels where the upper deck is substantially higher that the top of the ballast tank. Furthermore, it can be conveniently fitted to existing conduits extending from the ballast tank to the upper-deck level.

Alternatively, the first and second portions may be formed of generally concentric conduits. In this arrangement a distal end of the first portion extends into the second portion which is generally in the form of a tube having a sealed end and arranged to receive a quantity of fluid. The middle portion is thereby formed between the distal end of the first portion and sealed end of the second portion. This arrangement is particularly convenient where the upper deck level is generally at the same level as the top of the ballast tank.

The quantity of liquid is preferably selected to correspond to the maximum allowable pressure in the tank.

In operation the second portion is preferably connected to the ballast tank and the first portion is arranged to communicate with atmosphere. As pressure increases in the tank, for example by the introduction of nitrogen, air is displaced and bubbles through the fluid in the middle section.

It will be appreciated that the middle section essentially acts as a air-lock allowing gas to flow in either direction depending on the pressure differential between the first and second portions and the height of fluid contained in the middle section.

In either arrangement a separate valve may be provided which can be opened to allow gas to rapidly enter or leave the ballast tank or tanks. This may be preferable when loading and unloading the tanks whereas during introduction of nitrogen the valve discussed above may be used to retain the inert gas in the head-space.

It will be appreciated that this valve may be an integral part of the ballast water tank or may alternatively be a valve which can conveniently be retro-fitted to an existing ballast water tank.

It will be appreciated that the features described in the following embodiments, in the description and in the appended claims, can conveniently be used in isolation or in combination with each other to provide a complete ballast water treatment system.

Embodiments of the invention will now be described further by way of example and with reference to the accompanying drawings, in which:

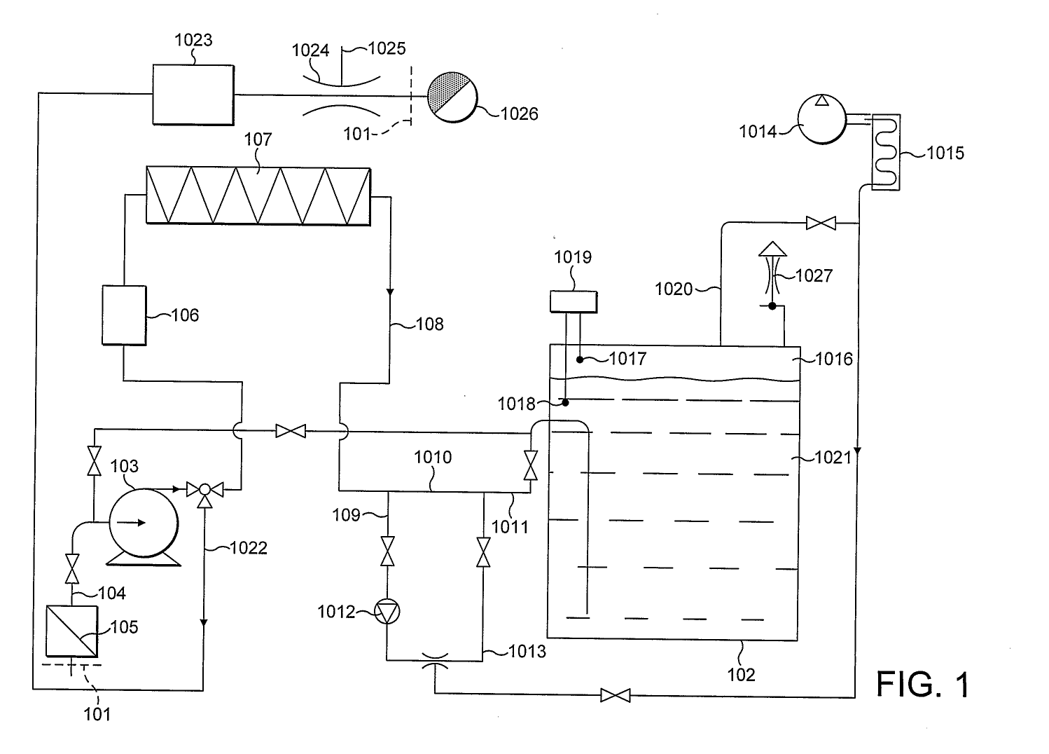

FIG. 1 is a schematic diagram of an apparatus according to the invention;

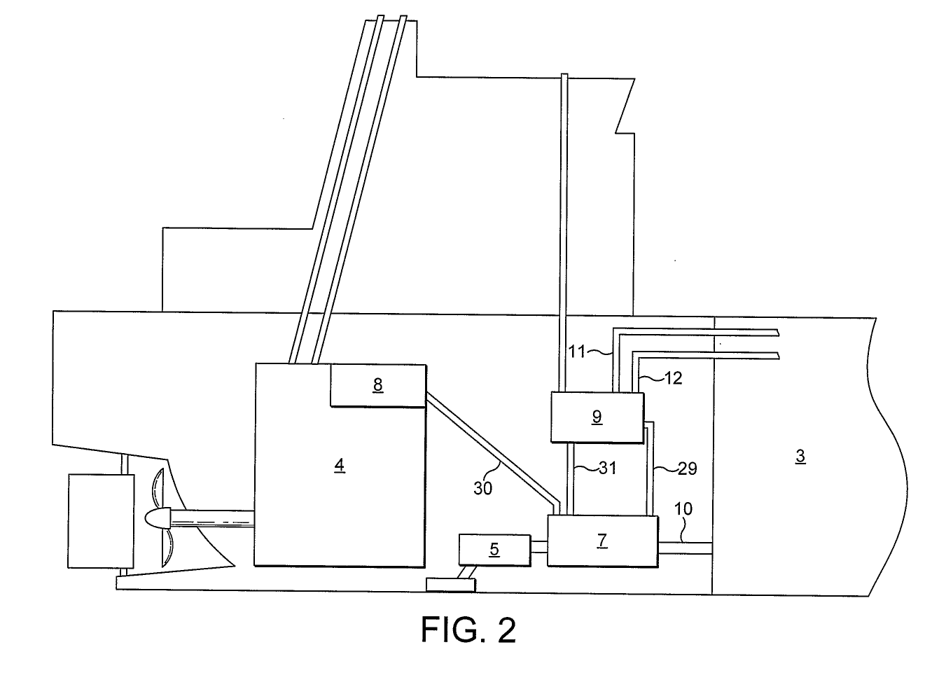

FIG. 2 shows an apparatus as installed in a ship and integrated with its structure (the particular ship used for this illustrative purpose is one with a double skin hull);

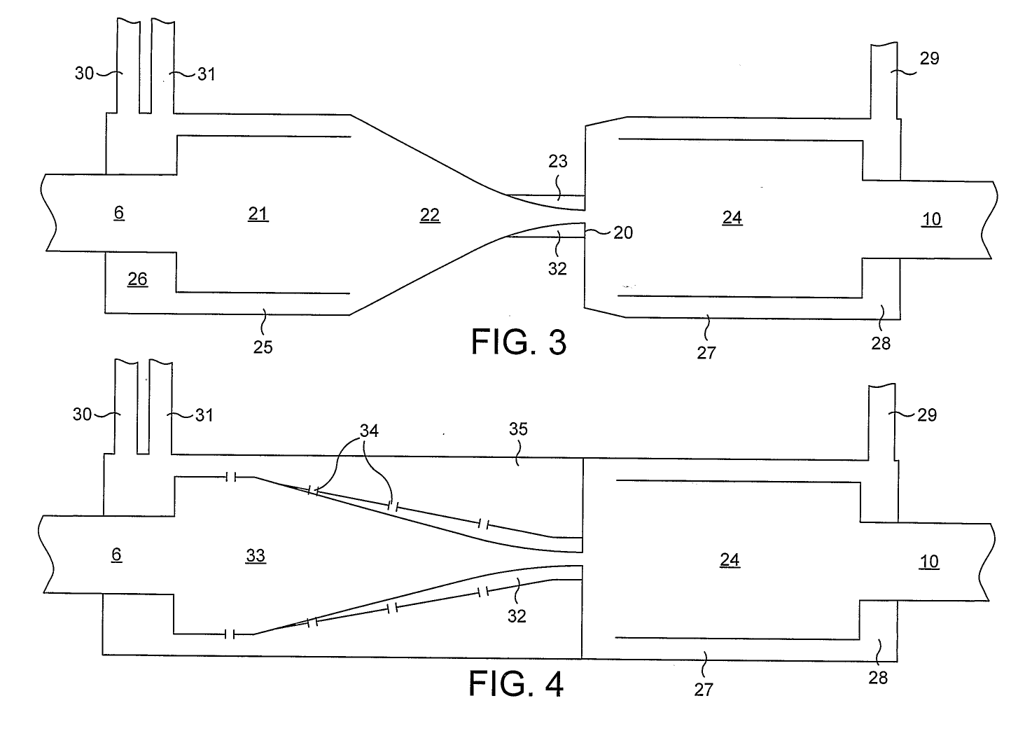

FIG. 3 is a schematic view in cross section of a closed circuit water treatment device (C3);

FIG. 4 is a schematic view in cross section of another embodiment of the water treatment device;

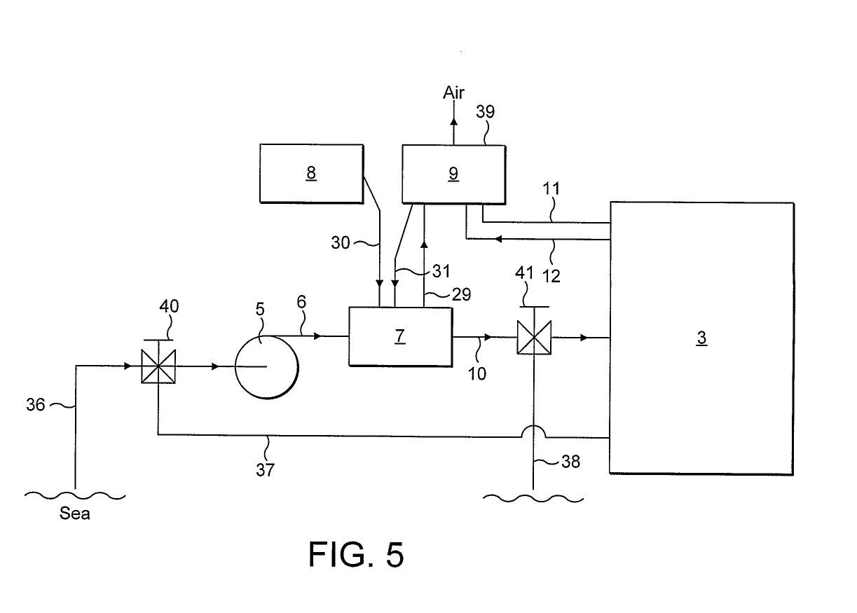

FIG. 5 shows an arrangement when filling the ballast tanks in a ship with water from the surrounding sea;

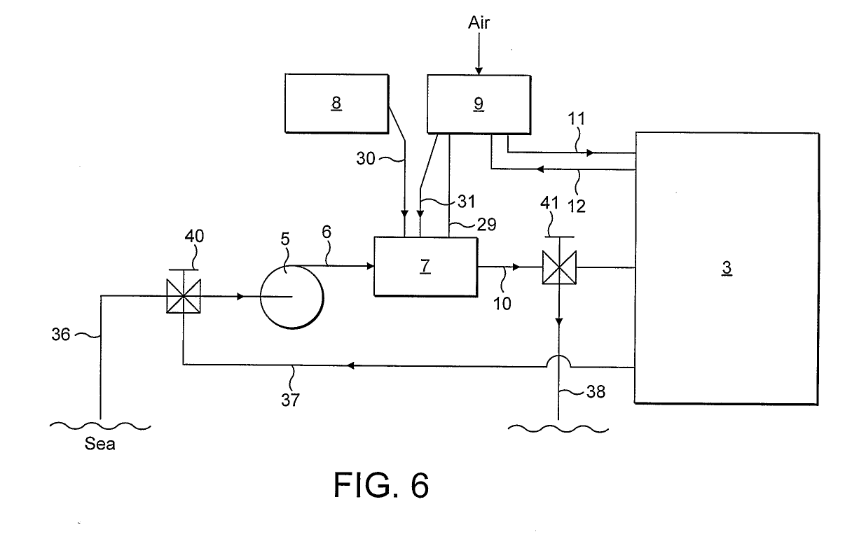

FIG. 6 shows the arrangement, when subsequently discharging the water into the sea again;

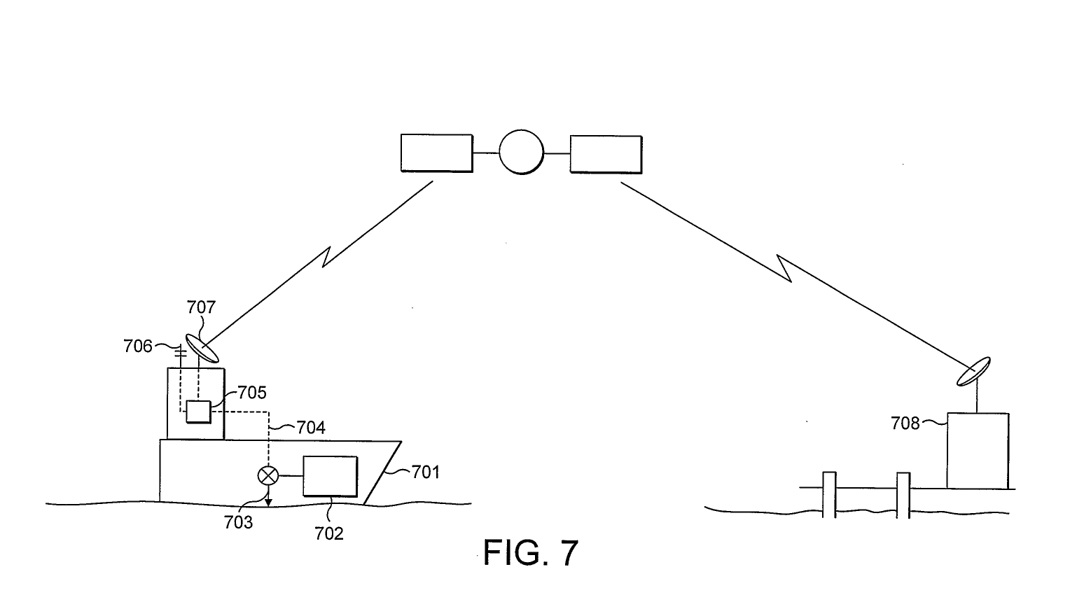

FIG. 7 shows an arrangement where the vessel communicates data to a coastal authority;

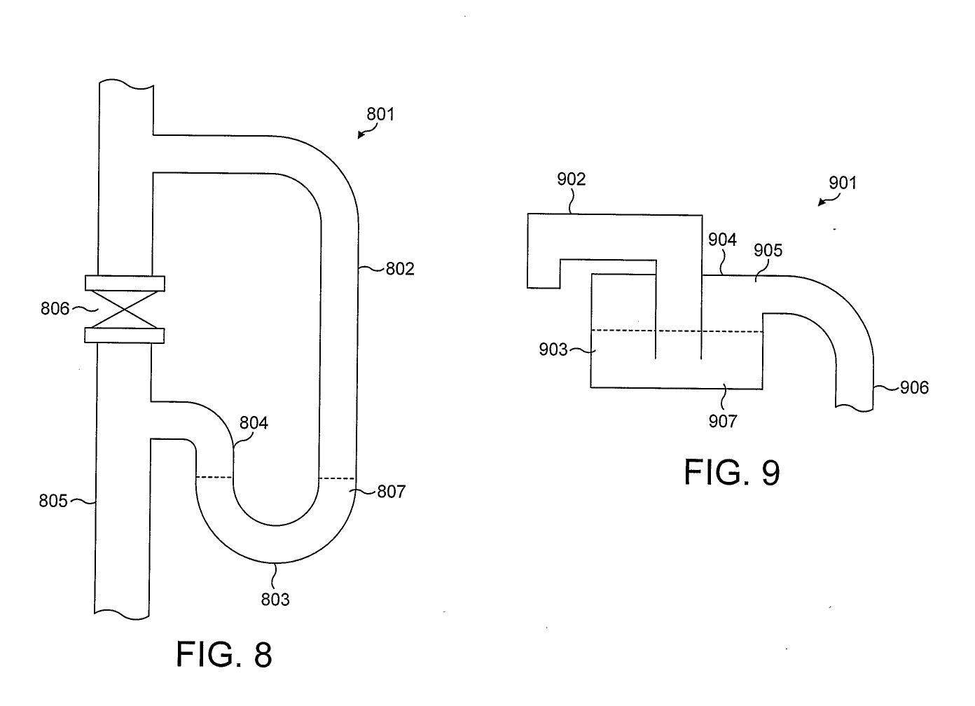

FIG. 8 shows a ballast tank pressure valve in a first arrangement; and

FIG. 9 shows a ballast tank pressure valve in a second arrangement.

Referring to FIG. 1 there is shown a ship 101 (indicated by a dashed line) having a ballast tank 102 and a ballast water pump 103.

Pump 103 draws in ballast water through a conduit 104 and coarse filter 105 before passing it via a 1 mm filter 106 and a 25 μm filter 107 and through conduits 108, 109, 1010 and 1011 into the ballast tank 102. About 10% of the water flow is directed through conduit 109, and pumped by additional pump 1012 through a Venturi nitrogen injector 1013 where pressurized nitrogen from air compressor 1014 and nitrogen generator 1015 is injected into this stream. The nitrogenized streams and non-nitrogenized streams are reunited in conduit 1011 and enter ballast tank 102 at about 130% nitrogen saturation. Bubbling off of nitrogen will generally fill tank headspace 1016 with nitrogen. The ballast tank 102 is provided with nitrogen sensors 1017 and 1018 attached to monitor 1019. The headspace is also provided with a valve 1027 (two different arrangements of valves are shown in FIGS. 8 and 9) which opens in response to headspace over or underpressure <60 mm H₂O. Alternatively valve 1027 may serve to vent overpressure in the headspace and an extra optional line 1020 may serve to introduce nitrogen when the nitrogen content in the headspace and/or empty tank falls below a certain desired level.

FIG. 2 shows a conventional double skin vessel which may be a tanker or any other kind of vessel that has been equipped with the inventive ballast water treatment system. The ship includes a double skinned hull with ballast tanks 3 installed between the skins. The ship is driven by propulsion machinery 4. A pump 5 pumps water from the surrounding sea through a ballast water treatment unit 7. Nitrogen is supplied to the ballast water treatment unit from a respiration or controlled atmosphere ventilating unit 9 using membrane technology or similar to separate oxygen and nitrogen from air. The ballast water treatment unit is also fed with steam generated from any excess heat (e.g. from exhaust gas) or from a boiler 8. Steam generators are already commonly installed in most ships; the stream being used for heating the heavy fuel. Released oxygen from the ballast water is simultaneously removed from the ballast water system and tanks and vented off into the atmosphere either through ventilators 29 connected to individual tanks or sets of tanks or through the integrated tank ventilation system through pipes 11 or 12 via the gas control unit 9. The water is pumped into the ballast tanks via pipes 10. Pipes 11, 12 connect the tops of the ballast tanks to the gas control unit 9, for controlling the gas content of the tanks. For ships where this arrangement is not feasible, ventilation will be ensured conventionally directly to above deck but managed by overpressure valve to ensure that air is not sucked into the respective tanks. The system shown in FIG. 2 may also include an optional filtering unit preceding the ballast water treatment unit 7.

The ballast water treatment unit 7 is depicted in FIG. 3. This consists of a cylindrical intake chamber 21 integrated with an inlet ballast water pipe 6. The cylindrical intake chamber 21 is followed by a conical section 22 leading to a narrow cylindrical tube 23. The cylindrical tube 23 is connected to a wider section or chamber acting as a cavitation chamber 24. The conical section 22 and/or the narrow cylindrical tube 23 may include a spiral-shaped edge or vane 32. The vane 32 will induce a rotary movement causing a momentum to the fluid flowing through.

One or more injection tubes 25 are inserted or incorporated in the intake chamber 21. This/these injection tube/tubes 25 receive steam and nitrogen gas from the external units 8 and 9, and deliver the gases to the intake chamber 21. The gases may be mixed in a mixing chamber immediately before entering the injection tubes 25 (not illustrated), or become mixed in an annular manifold 26 surrounding the water inlet pipe 6. The gas mixture is mixed with water in the intake chamber 21. It is preferred to use a multitude of gas injection tubes 25 at the periphery of the intake chamber 21.

A similar arrangement of one or more small gas outlet tubes 27 may be inserted or incorporated to the cavitation chamber 24, with openings at the periphery of the chamber acting as ventilators for the purpose of removing released oxygen. The tubes are leading to an annular gas outlet manifold 28. The manifold 28 is connected to the gas control unit 9 by a venting pipe 29. It is preferred to use a multitude of gas outlet tubes 27 at the periphery of the cavitation chamber 24, albeit it is possible to use only a single gas outlet tube 27.

When in operation, seawater is being fed by the ballast water pump 5 into the cylindrical intake chamber 21 and further through the conical section 22 to the cylindrical tube 23 and then into the cavitation chamber 24. The physical conditions for cavitation, or close-to-cavitation conditions to occur are achieved by the manipulation of the ballast water consistence and thus its vapour-point and by lowering the internal fluid pressure. At the edge 20 between the cylindrical tube and the cavitation chamber, cavitation is initiated. At the cylindrical tube, the velocity of the fluid will have increased and the hydrostatic pressure decreased to, or close to the vapour-point of the modified ballast water (the fluid), resulting in the formation of bubbles. The spiral-shaped edge or vane 32 will initiate the collapse of such bubbles in combination with the dramatic pressure change over the edge 20 between the cylindrical tube 23 and the cavitation chamber 24. These actions will initiate hydrodynamic forces causing the bubbles to implode and thus release energy in the form of pressure impulses and peaking temperatures.

The water velocity is boosted by the jet action from the mixture of steam and nitrogen entering the water from the gas supply tube(s) 25. The steam will have only a negligible effect on the temperature in the water as only a very limited amount is required to create the booster effect. This booster effect is further promoted as the volume of nitrogen increases due to the immediate change in the density of the nitrogen. The bubbles will change the rheological properties of the water, such as the overall density and viscosity. As the nitrogen is cooled down by the surrounding water, it will partly shape bubbles and partly be gradually dissolved by the water. This process will initiate the release of oxygen.

After passing the cylindrical tube 23 and exposed to the actions of the inserted edge 20, the bubbles formed will subsequently collapse on entry to the cavitation chamber 24. The implosion of the bubbles will destroy organic cell membrane and tissue present in the water. A steady and controlled cavitating action will occur in the ballast water due to the particular design of the cavitation chamber creating a dramatic pressure change.

An effect of the cavitating action is that a significant part of the oxygen present in the water will become released. This oxygen may be removed by the gas outlet tubes 27 surrounding the cavitation chamber or through the vessel's tank ventilation system 12. Surplus nitrogen not already saturated into the fluid will replace the oxygen released due to cavitation and prevent it to be absorbed and dissolved again by the water at any point in the process, also after the water have entered the ballast tanks 3.

The ballast water treatment unit has been described as including a cylindrical intake chamber 21, a conical section 22 and a cylindrical tube 23. This is the currently preferred embodiment of the invention. However, these elements may optimally be replaced with a single tapered section 33 as illustrated in FIG. 4. The gases may also be injected from several tubular openings 34 located both along the circumference and in the longitudinal direction of the tapered section 33, i.e. as a multi stage injection. In such an embodiment, an annular gas manifold may be designed as a chamber or box 35 on the outside of the tapered section 33 and along the full length of said tapered section.

From the cavitation chamber, ballast water that is low in oxygen content, typically 2 mg/ml, and low in living organisms are fed to the ballast tanks. The low oxygen content will promote the elimination or killing action further and act preventive against potential re-growth. The occurrence of corrosion and coating degradation caused by or dependent upon the presence of oxygen will be significantly reduced.

When unloading the ballast tanks, the gas control unit 9 will supply nitrogen to the tanks preventing oxygen or air to enter and by this controlling the maintenance of an atmosphere low on oxygen also when the tank is empty for water. This gas is supplied via the pipe 11. In prior art systems, venting tubes would supply outside air to the tanks when they are emptied of water. However, the present invention includes a closed gas control system that ensures a non-corrosive atmosphere in the ballast tanks. In case someone is about to enter a tank for inspection, the gas control unit 9 will replace the nitrogen atmosphere with normal breathable air through the pipe 12.

In case where the ventilation pipes 11 and 12 are not included, ventilation will be ensured by allowing air to enter via ventilators (not illustrated).

FIG. 5 is a schematic diagram over the inventive arrangement for ballast water treatment. The arrows indicate flow directions when the ship is loading ballast water. Water is entering the ship from the surrounding sea by pipe 36. The water is directed to pump 5 by a first three-way controlled valve 40. The pump 5 feeds the water treatment unit 7 via pipe 6. Steam and nitrogen gas is fed to the water treatment unit 7 by pipes 30 and 31, while released oxygen is removed via pipe 29, and the gas control unit 9. Eventually, the oxygen is vented off into the atmosphere by pipe 39. After treatment, the water is pumped into the ballast tank 3 via pipe 10 and a second three-way valve 41. The water is replacing gas in the ballast tank 3, and the gas is removed via pipe 12.

Discharge may be arranged in such a manner that the water is pumped again through the system as described above and again treated. At this time, the water may be exposed to oxygen or air via injection pipe 31 rather than nitrogen. The purpose of this is to ensure that water low on oxygen is not discharged in cases where the port or area of discharge is already deficient in oxygen levels. This is illustrated in FIG. 6. The ballast water is unloaded from the tank 3 by pipe 37, first three-way valve 40, pump 5, water treatment unit 7, second three-way valve 41, and discharged into the surrounding sea by pipe 38. In this case steam is supplied by pipe 30 and air or oxygen supplied by the pipe 31. Thus, the water discharged into the sea will have restored oxygen content. The water removed from the tank 3 is replaced with nitrogen gas supplied from the gas control unit 9 via pipe 11 in order to maintain an oxygen-depleted atmosphere in the tank.

While the invention has been described as a system and method for treatment of ballast water in ships, it may also find other applications. One such application is for treatment of waste water, e.g. sewage. During summertime superfluous energy may be available from industry plants, e.g. waste incinerators. The incinerators may supply energy to drive a cavitation unit, as well as oxygen stripping gas. Carbon dioxide may be used as oxygen stripping gas, as the corrosive action of this gas is of no consequence under these conditions. Other applications are in large air conditioning plants, or in food and drinks processing industries, for controlling bacterial levels. These other applications form part of the invention and may be as defined in the appended claims altered only to apply to sewage, etc as opposed to ballast water.

FIG. 7 shows the arrangement where the vessel provides data to a coastal authority indicating where and when the ballast tanks have been emptied.

The vessel 701 is provided with ballast tank 702 and discharge pump 703. The discharge pump is controlled by the vessel's control system (not shown) and is arranged to provide a signal on control line 704 to the ballast water control unit 705. Ballast water control unit 705 receives a GPS signal indicating the vessel's coordinates from GPS receiver 706. The control unit 705 is also connected to a satellite transmitter/receiver 707 to communicate data to and from the coastal authority 708.

In operation the control unit receives data from the coastal authority indicating the requirements for discharging the ballast water i.e. the distance from the coast. This data is stored in the control unit. The control unit receives the vessel's coordinates from the GPS receiver and stores this data. When the discharge pumps are operated a control signal is received by the control unit 705 which logs the time and location at which the pumps were operated. This data can then be automatically transmitted to the coastal authority 708 indicating if the vessel has complied with the relevant laws.

In a further embodiment the control unit may be arranged to indicate to the vessel crew that they are approaching the legal limit for discharging the ballast tanks.

FIG. 8 shows a ballast tank pressure valve in a first arrangement.

The valve 801 is formed of a first portion 802 connected to a U-section middle portion 803. The U-section 803 is connected to a section portion 804. First and second portions 802 and 804 are connected to a vertical conduit 805 which is connected at the bottom to the ballast tank (not shown) and at the top to atmosphere. A valve 806 is located in the conduit 805 to allow air into and out of the tank during loading and unloading.

In operation, the tank is loaded with the valve 806 open. Once the ballast tank is full valve 806 is closed. Nitrogen is then introduced into the head-space which displaces the air in the headspace increasing the pressure. As the pressure increases the air bubbles through the liquid 807 in u-section 803. The level of liquid defines the pressure at which the air will bubble through.

Once the air has been displaced the valve permits gas to move into and out of the tanks as the pressure difference between the first and second portions changes.

FIG. 9 shows a ballast tank pressure valve in a second arrangement.

The valve 901 is formed of a first portion 902 extending into the second portion 903 formed as a sealed tube or ‘drum’. The first and second portions are sealed by connection 904 to form a cavity 905 within the second portion 903. The cavity 905 communicates with the ballast tank (not shown) via conduit 906.

In this arrangement the pressure increases in the cavity 905 as the pressure in the ballast tank rises. The second portion 903 is partially filled with a liquid 907 which acts as an air lock between the first and second portions. In the same way as discussed above, with reference to the first valve arrangement, as the pressure increases gas can bubble through the liquid and out to atmosphere through the first portion 902. Similarly, any excess pressure in the tank can be automatically relieved by the valve.

It will be appreciated that a range of different configurations of conduits and a liquid level can be used to achieve a ballast water pressure valve of the type herein described.

1. A method of ballast water treatment which comprises: pumping water from a water source (e.g. surrounding sea, lake or river) through a filter to the ballast tank of a water-going vessel; raising the dissolved nitrogen content of at least part of said water to a level above the nitrogen saturation content thereof whereby the water in said ballast tank when pumping is terminated is above the nitrogen saturation content thereof and below the oxygen saturation content thereof; maintaining in the headspace of said ballast tank an atmosphere having greater than atmospheric content of nitrogen (in mole %); pumping water from said ballast tank into the water surrounding said vessel; and subjecting the water pumped from said ballast tank to a microorganism-killing action before the release thereof into said water surrounding said vessel.

2. An apparatus for the treatment of ballast water for a water-going vessel, said apparatus comprising: a first pump for pumping water through a filter and into a ballast tank; a filter through which water may be pumped by said first pumping water through a filter and into a ballast tank; a filter through which water may be pumped by said first pump; a conduit for carrying water from said first pump through said filter to said ballast tank; a nitrogen introducer for introducing nitrogen into water being pumped from said first pump to said ballast tank; optionally a nitrogen source attached or attachable to said nitrogen introducer; a second pump (which may optionally and preferably be said first pump) for pumping water from said ballast tank through a conduit and out of said vessel; and a microorganism killing unit arranged to kill microorganisms in water being pumped from said ballast tank and out of said vessel.

3. A method of ballast water treatment which comprises: pumping water from a water source (e.g. surrounding sea, lake or river) through a filter to the ballast tank of a water-going vessel; pumping water from said ballast tank into the water surrounding said vessel; and subjecting the water pumped both to and from said ballast tank to a microorganism-killing action before the release thereof into said water surrounding said vessel.

4. An apparatus for the treatment of ballast water for a water for a water-going vessel, said apparatus comprising: a first pump for pumping water through a filter and into a ballast tank; a filter through which water may be pumped by said first pump; a conduit for carrying water from said first pump through said filter to said ballast tank; and a microorganism killing unit arranged to kill microorganisms in water being pumped both to and from said ballast tank.

5. A method as claimed in claim 1 wherein ballast water is oxygenated before discharge from said vessel.

6. Apparatus as claimed in claim 2 further comprising an oxygen introducer arranged to oxygenate ballast water before discharge thereof from said vessel.

7. A water-going vessel having a ballast water tank, characterized in that said vessel further comprises apparatus according to claim 2.

8. A method for treatment of ballast water, said method comprising
pumping water from a first repository,
adding steam to the water,
adding a further gaseous material to the water,
introducing a cavitation action in the water, and
conducting the water to a second repository.

9. A method as claimed in claim 8,
wherein the steam is mixed with the further gaseous material prior to being added to the water.

10. A method as claimed in claim 8,
further comprising introducing a rotation movement to the water before the cavitation step.

11. A method as claimed in claim 8,
wherein said first repository is the sea, said further gaseous material is an oxygen-stripping gas, said method including an additional step of removing oxygen from the water before or after the water is conducted to the second repository, said second repository being a ballast tank.

12. A method as claimed in claim 11,
wherein oxygen is removed from the water both before and after the water is conducted to the second repository.

13. A method as claimed in claim 8,
wherein said first repository is a ballast tank, said further gaseous material is a gas containing oxygen and, said second repository is the surrounding sea.

14. An arrangement for treatment of ballast water,
including a pump pumping water from a first repository, characterized in that said arrangement comprises
means for adding steam to the water,
means for adding a further gaseous material to the water, means for introducing a cavitation action in the water
means for conducting the water to a second repository.

15. An arrangement as claimed in claim 14,
further comprising means for mixing the steam and the further gaseous material before the mixture is added to the water.

16. An arrangement as claimed in claim 14,
further comprising means for introducing a rotation movement to the water before entering said cavitation means.

17. A method as claimed in claim 14,
wherein said first repository is the sea, the second repository is a ballast tank, said further gaseous material is an oxygen-stripping gas, said arrangement including means for removing oxygen from the water.

18. An arrangement as claimed in claim 17,
wherein the oxygen stripping gas is nitrogen.

19. An arrangement as claimed in claim 14,
wherein said first repository is a ballast tank and said second repository is the surrounding sea, said further gaseous material being a gas containing oxygen.

20. An arrangement as claimed in claim 17,
further comprising means for controlling the atmosphere in said ballast tank in order to provide an atmosphere low in oxygen.

21. An arrangement as claimed in claim 20,
further comprising ventilation means connecting said ballast tank to the outside air, said means for controlling the atmosphere in the ballast tank being arranged to supply a gas displacing air or oxygen present in the tank.

22. An arrangement as claimed in claim 20,
wherein said means for controlling the atmosphere in the ballast tank is arranged to vent off overpressure gases from the tank when ballast water is filled into the tank, and supply an oxygen-depleted gas to the tank when ballast water is discharged from the tank.

23. A device for treatment of ballast water, for use in an arrangement as claimed in claim 4, said device comprising a liquid inlet pipe (6) supplying ballast water to the liquid treatment device (7), an intake chamber (21) connected to the inlet pipe (6), a conical section (22) connected to the intake chamber (21),
a tube (23) connected to the conical section (22),
a cavitation chamber (24) connected to the tube (23),
a liquid outlet tube connected to the cavitation chamber (24) and conducting the liquid from the cavitation chamber (24), and
at least one gas supply tub (25) supplying steam and a further gaseous material to the intake chamber (21).

24. A device as claimed in claim 23,
comprising at least one oxygen outlet tube (27) connected to said cavitation chamber (24), at least one oxygen outlet tub (27) being arranged to remove oxygen from the cavitation chamber (24).

25. A device as claimed in claim 23,
comprising a plurality of gas supply tubes (25) are surrounding the intake chamber (21), each gas supply tube (25) being connected to the intake chamber (21) in one end, the other end being connected to a common annular manifold (26).

26. A device as claimed in claim 23,
comprising a plurality of oxygen outlet tubes (27) are surrounding the cavitation chamber (24), each oxygen outlet tube (27) being connected to the cavitation chamber (24) in one end, the other end being connected to a common annular gas outlet manifold (28).

27. A device as claimed in claim 23,
comprising at least one vane (32) in said conical section (22) and/or in said tube (23), said vane (32) being arranged to introduce a rotation movement to the ballast water conducted through the conical section (22).

28. A device (7) for treatment of ballast water, for use in an arrangement as claimed in claim 4, said device comprising a liquid inlet pipe (6) supplying a liquid to the liquid treatment device (7),
a tapered section (33) connected to the inlet pipe (6), a cavitation chamber (24) connected to the tapered section, a liquid outlet tube (10) connected to the cavitation chamber (24) and conducting the liquid from the cavitation chamber (24),
means (34) for adding steam and a further gaseous material to the intake chamber (21).

29. A device as claimed in claim 28,
comprising at least one oxygen outlet tube (27) connected to said cavitation chamber (24), the oxygen outlet tub (27) being arranged to remove oxygen from the cavitation chamber (24).

30. A method as claimed in claim 28,
comprising a manifold (35) on the outside of said tapered section (33), a number of openings (34) in the tapered section (33) for injecting steam and further gaseous material into ballast water inside the tapered section (33).

31. A device as claimed in claim 28,
comprising at least one vane (32) in said tapered section (33), said vane (32) being arranged to introduce a rotation movement to the ballast water conducted through the tapered section (33).

32. A ballast water control system comprising a control unit and data storage means, the control unit being arranged to receive an indication that a ballast water tank has been emptied and an indication of the coordinates of the vessel and to store both indications in said data storage means.
